(19) United States
(12) Patent Application Publication
(10) Pub. No.: US 2020/0311768 A1
(43) Pub. Date: Oct. 1, 2020

(54) SYSTEM FOR TRIGGERING LEAD QUALIFICATION AND NURTURING BASED ON CUSTOMER ACTIONS

(71) Applicant: Microsoft Technology Licensing, LLC, Redmond, WA (US)

(72) Inventors: Aditya Makarand DESAI, Issaquah, WA (US); Elie ABI CHAHINE, Redmond, WA (US); Dina Marie VACCARI, Seattle, WA (US); Prashant KUMAR, Issaquah, WA (US)

(73) Assignee: Microsoft Technology Licensing, LLC, Redmond, WA (US)

(21) Appl. No.: 16/368,750

(22) Filed: Mar. 28, 2019

(51) Int. Cl. G06Q 30/02

(52) U.S. Cl. CPC G06Q 30/0255; G06Q 30/0264

(57) ABSTRACT

A system and method of nurturing one or more leads is provided. Initially, an indication that a lead has interacted with an ecommerce site may be received, where the indication includes information uniquely identifying the lead and one or more interactions with the ecommerce site. Contact information for the lead may be retrieved. The lead may then be qualified based on the information identifying one or more interactions with the ecommerce site. The lead may then be associated with at least one of a sales professional or sales group and a template may be selected based on the at least one of the sales professional or sales group. Accordingly, a communication message, which may be an email, may be sent to the lead utilizing the contact information and the selected template, where the communication message includes sender information associated with at least one of the sales professional or sales group.

### BACKGROUND

Potential clients interact with websites and online marketplaces when showing interest in one or more products. For example, a potential client may interact with an online marketplace that offers a free trial of a product or service. Transferring these potential clients into actual clients is often difficult, as there may be one or more features of the product or service that are limited during the free trial and the potential clients may lose interest or otherwise become disinterested in the trial product or service. Similarly, potential clients may interact with various portions of a marketplace but may ultimately leave the marketplace without purchasing a product or service and without directly requesting additional information or follow-up regarding a product or service. Accordingly, the opportunity to turn the user into a client often passes and the marketplace loses a potential client.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods that nurture one or more leads based on an indication that the lead interacted with an ecommerce website and/or marketplace. For example, an indication may be received that indicates the lead would like additional information with respect to a specific product or service. Contact information for the lead may be obtained and the lead may be filtered, qualified, and assigned or associated to one or more sales professionals and/or sales groups. An automated, but human-like, email message may be sent to the lead within a specified time period of receiving the indication that the lead interacted with the ecommerce website or marketplace. In some examples, the email message may include a document reference identifier which uniquely identifies the lead and the message sent to the lead such that when the lead replies to the email, the response message may include the document reference identifier in the body of the email or as metadata. When the response message is received, the text of the response may be analyzed to determine if the lead is more or less likely to represent a purchasing end customer. If the lead is more likely to represent a purchasing end customer, the lead may be assigned or associated with a sales professional and/or a sales group based on the interaction with the ecommerce website and/or marketplace. In instances where the lead has not responded to the initial message, a follow-up message may be automatically sent to the lead.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates details of a lead generation and nurturing system in accordance with the aspects a of the disclosure;

FIG. 2 depicts additional details of the lead nurturing system in accordance with examples of the present disclosure;

FIG. 3 depicts details of a marketplace site in accordance with examples of the present disclosure;

FIG. 4 depicts user interface details associated with one or more products offered by the marketplace in accordance with examples of the present disclosure;

FIG. 5 depicts additional details of the lead generation and nurturing system in accordance with examples of the present disclosure;

FIG. 6 depicts details of a method for obtaining lead information and sending an initial message to the lead in accordance with examples of the present disclosure;

FIG. 7 depicts details of a method of receiving a response from the lead and associating the lead with one or more of a sales professional or group;

FIG. 8 depicts details of a method for sending a follow-up message to the lead in accordance with examples of the present disclosure;

FIG. 9 is a block diagram illustrating example physical components of a computing device with which aspects of the disclosure may be practiced;

FIG. 10A is a simplified block diagram of a computing device with which aspects of the present disclosure may be practiced;

FIG. 10B is another are simplified block diagram of a mobile computing device with which aspects of the present disclosure may be practiced; and

FIG. 11 is a simplified block diagram of a distributed computing system in which aspects of the present disclosure may be practiced.

### DETAILED DESCRIPTION

Various aspects of the disclosure are described more fully below with reference to the accompanying drawings, which form a part hereof, and which show specific example aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

As discussed above, potential clients may take various actions at application marketplaces and e-commerce websites; such interactions may be interpreted as one or more engagement signals. From the engagement signals, one or more corresponding leads may be generated and may be incorporated in to a customer relationship management (CRM) product. The goal in generating such leads is to have a dedicated team of inside sales representatives' call and contact these leads, qualify the leads, and share the lead with potential marketplace partners to drive an established co-selling process.

However, the process of lead nurturing or lead qualification is typically executed by a team of inside sales professionals that typically call/email the customer to gauge the level of qualification of a lead based on typical budge, authority, need, and timeline (BANT) criteria. However, a human sales professional engaging with the potential end customer typically takes the sales professional multiple days to reach the potential end customer or worse, reach only a subset of customers. Larger organizations attempt to reduce the time to contact the potential end customer by hiring sales organizations with twenty-four hour sales team rotation(s) which increases the cost of running the sales organization. A Harvard Business review study indicates that the average response time was forty-two hours for a sales professional to attempt establish contact with the potential end customer or lead. This is problematic, as various studies have validated that contacting a lead under an hour from when the lead is generated increases the likelihood of qualification by seven times.

Accordingly, based on certain signals generated by potential leads interacting with products on a marketplace or e-commerce website, the potential lead may be contacted utilizing a template used by inside sales representatives. For example, an email template used by inside sales representatives may be automatically sent to a potential lead within a specific time of the potential lead generating such signals through marketplace interactions. Moreover, the email may be sent form a service account that appears to be coming from a real individual. In accordance with at least one example of the present disclosure, a lead may be emailed within forty-five minutes of generating the one or more signals. Moreover, follow-up emails may be automatically sent to the potential lead if the potential lead has not replied to the initial email. Alternatively, or in addition, if a reply from the potential lead is received, information about the potential lead may be provided to the inside sales team such that the inside sales team can follow-up with the potential lead to drive meaningful conversations with the potential lead in hopes of turning the potential lead into a client.

In cases where the potential lead responds with a “strong-negative” sentiment, the potential lead may be identified as a “Hot” lead and provided to the inside sales professionals. That is, a “Hot” lead may be one which typically indicates a highest dis-satisfaction with a current product or service and may represent a large opportunity. Leads classified with a “strong-positive” sentiment tend to indicate a higher satisfaction and hence little opportunity, to turn the potential lead into an end customer. Such leads having a higher satisfaction may be classified as a “Warm” lead and may be provided to the inside sales professional with the “Warm” lead designation.

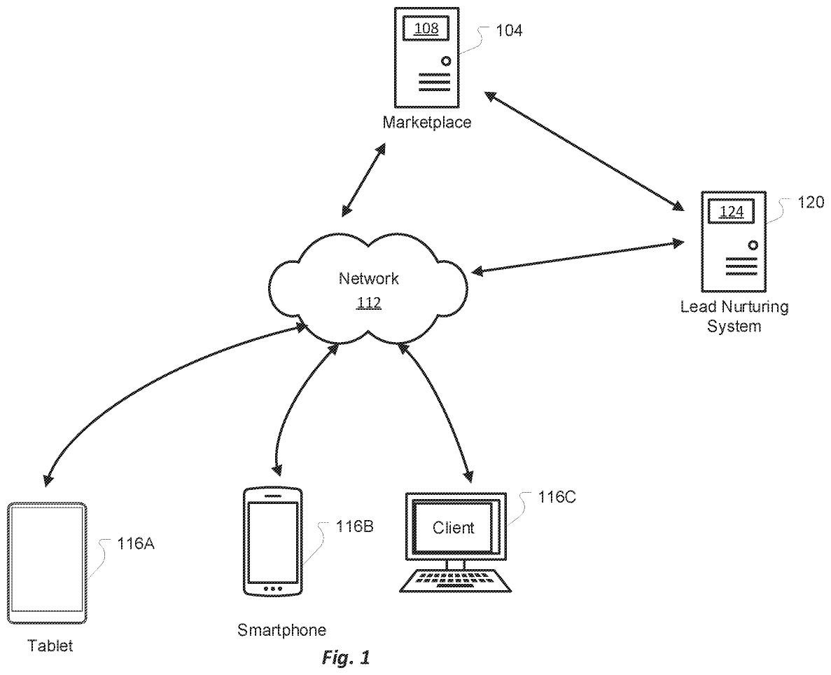

FIG. 1 depicts aspects of a lead generation and nurturing system 100 in accordance with examples of the present disclosure. The lead generation and nurturing system 100 may include a marketplace 104, such as an ecommerce site for example, where the ecommerce site provides an interface for one or more users to view one or more products and/or services that may be provided by a specific company and/or entity. The marketplace 104 may specific to a single company or may be a shared marketplace such that various companies and/or entities advertise or otherwise market products and services. A user may interact with the marketplace 104 utilizing one or more user devices 116A-116C. In some examples, the user device 116A-116C may correspond to a tablet 116A, a smartphone 116B, and/or a client device 116C. As another non-limiting example, at least one client device 116A-116C may be any device configured to allow a user to use an application such as, for example, a smartphone, a tablet computer, a desktop computer, laptop computer device, gaming devices, media devices, smart televisions, multimedia cable/television boxes, smart phone accessory devices, industrial machinery, home appliances, thermostats, tablet accessory devices, personal digital assistants (PDAs), or other Internet of Things (IOT) devices.

The marketplace 104 may include a lead interaction generator 108 that identifies one or more characteristics associated with a user interacting or otherwise engaging with the marketplace 104. For example, the lead interaction generator 108 may determine that a user is interested in a specific product or service due in part because a user interacted with content specific to a product or service for a specified period of time. Alternatively, or in addition, a user may have indicated a specific interest in a specific product or service and/or may have submitted contact information for follow-up. As previously discussed, the user may interact with the marketplace 104 utilizing one or more user devices 116A-116C. The lead interaction generator 108 of the marketplace 104 may provide one or more leads to the lead nurturing component 120. The lead nurturing component 120 may include a lead nurturing system 124 configured to nurture the lead into an end customer. That is, the lead nurturing system 124 may classify the lead based on information obtained or otherwise gathered about the lead including the one or more products or services in which the lead was interacting with at the marketplace 104. The lead nurturing system 124 may automatically send a message to the lead to imitate or otherwise impersonate a human response. That is, the lead nurturing system 124 may send an email using an email template, where the composition of the email template is humanlike. If the lead responds to the email, the lead nurturing system 124 may classify the response and pass the classified response to an appropriate inside sales professional for additional follow-up. Alternatively, or in addition, if a response from the lead is not received at the lead nurturing system 124, the lead nurturing system 124 may send a follow-up message at one or more specified time intervals until either a number of messages sent exceeds a threshold or the lead responds to the message.

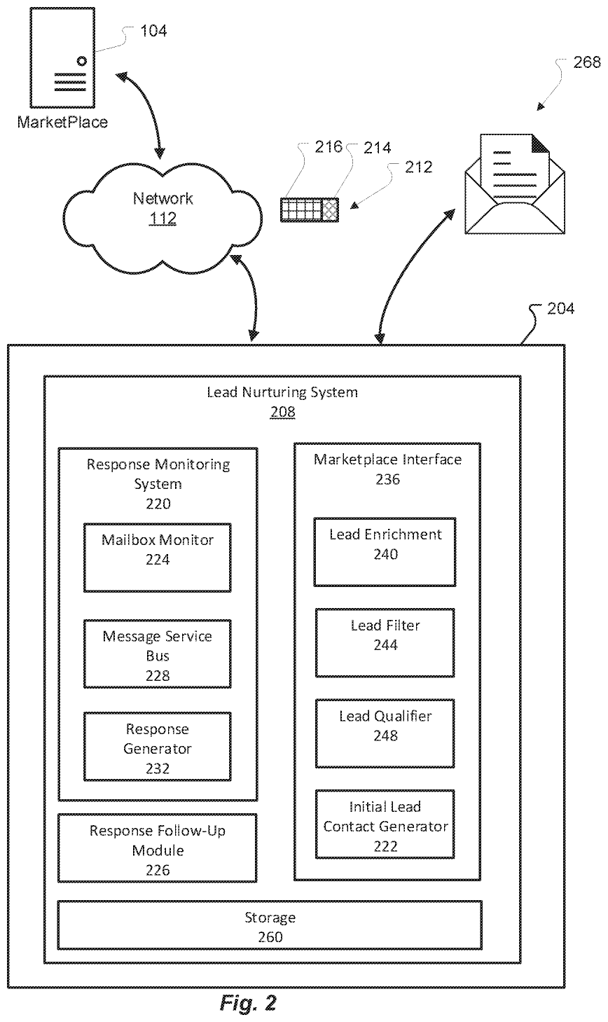

FIG. 2 depicts additional details of the lead nurturing system 124 in accordance with examples of the present disclosure. More specifically, FIG. 2 depicts a lead nurturing component 204 which may be the same as or similar to the lead nurturing component 120. The lead nurturing component 204 may refer to or otherwise reside at one or more data processing devices, such as one or more servers or the like, and may include a lead nurturing system 208, where the lead nurturing system 208 may be the same as or similar to the lead nurturing system 124. The lead nurturing system 208 may include a response monitoring system 220, a marketplace interface 236, a response follow-up module 226, and storage 260. In accordance with examples of the present disclosure, the lead interaction generator 108 of the marketplace 104 may determine that a user interacts with one or more components, products, and/or services of the marketplace 104 or otherwise shows an interest on or more components, products, and/or services of the marketplace 104. Thus, the lead interaction generator 108 of the marketplace 104 may provide user information as lead information 212, where the lead information 212 may include lead identifying information 214 and interaction information 216. The lead information 212 may include, but is not limited to, a name of the lead, lead contact information, and/or other information that may be utilized to uniquely identify a lead, such as but not limited to a username. The interaction information 216 may include information indicative of one or more products or services that the user, prior to becoming a lead, interacted with at the marketplace 104. As another example, the interaction information 216 may uniquely identify a product and/or service that the user interacted with, may include information about each interaction, such as but not limited to interaction timing information indicating how long a user interacted with a specific portion of the marketplace 104 correspond to one or more products and/or services, interaction patterns, and/or feedback and/or comments submitted by the user. The marketplace 104 may provide the lead information 212 to the marketplace interface portion 236 of the lead nurturing system 208.

The marketplace interface portion 236 may include a lead enrichment module 240, a lead filter 244, a lead qualify 248, and an initial lead contact generator 222. The lead enrichment module 240 may identify additional information associated with the lead information 212. For example, the lead information 212 may include user identification information, such as a username. However, the lead information 212 may be lacking contact information, such as an email address. Thus, the lead enrichment module 240 may enrich the lead information 212 by querying one or more systems and/or storage locations to determine contact information, such as an email address, that may be associated with the lead identification information provided in the lead information 212. Additional enriching information may be obtained as well. Moreover, the lead nurturing system 208 may access one or more storage locations, such as storage 260, to enrich the lead.

The lead filter 244 may operate on the enriched lead information and may perform a “first pass” type of filtering to determine if the lead is actually a lead worth pursuing. For example, if a lead corresponds to an education lead, whereby the lead's contact information ends in .edu, the lead filter 244 may determine that in all likelihood, inside sales professionals already call on education institutions utilizing single points of contacts for example. Thus, the lead filter 244 may determine that the lead in the lead information 212 should not be passed to an inside sales professional and/or that an initial contact message should not be sent to the lead. The lead qualifier 248 may qualify the lead with respect to the product and/or services determined to be of interest by the lead. For example, based on a product identifier and/or service identifier received in the lead information 212, the lead qualifier may determine if the lead is already associated with the product and/or service of interest and/or if the lead is already working with an inside sales professional. In instances where it is determined that the lead is a new lead and represents a genuine inquiry into the product and/or service, the lead qualifier may associate inside sales information to the lead, such as a group the lead may be assigned to and/or the inside sales manager responsible for curating and/or nurturing the lead. Thus, the lead may be created in a customer relationship management (CRM) database for further lead tracking.

The initial lead contact generator may then determine that a message should be generated and sent to the lead, as the lead has been filtered and may have been qualified as a rapid first contact lead. Accordingly, the initial lead contact generator 222 may obtain an email template utilized to send the initial communication to the lead. For example, based on the lead information 212, a specific communication template, such as an email template may be chosen. Moreover, the email template may be customized to the product and/or service determined to be of interest by the lead and/or by the inside sales professional responsible for the lead should the lead provide a response to the initial communication. The communication template may then be populated with enriched lead information, such as the lead's name, and a message may be scheduled to be sent to the lead. For example, an email addressed to the lead may be placed in a queue and may be scheduled to be sent to the lead forty-five minutes after the lead interaction generator 108 provided the lead information to the lead nurturing system 208.

The response monitoring system 220 may monitor a mailbox associated with an address of which the initial communication was sent from. For example, the initial lead contact generator 222 may send an email communication to the lead utilizing a “from” email address indicative of a real human. In some instances, it may appear that the email was sent from an inside sales representative responsible of nurturing the lead. Moreover, the mail box monitor may record or otherwise keep track of the leads that have responded to the initial communication and track those leads that have yet to respond. For example, when the initial communication is sent, the mailbox monitor 224 may associate a document response identifier found in the initial communication with the lead and store the document response identifier in a storage location, such as storage 260. Accordingly, if a response is received, the response being a “reply” email would include the document response identifier. Thus, the mailbox monitor 224 may add the document response identifier to the message service 228.

The message service bus 228 may be responsible for processing each of the document response identifiers added by the mailbox monitor 224. Accordingly, the message service bus 228 may retrieve lead information associated with the document response identifier. The lead information and the document response identifier associated with a received response may be passed to the response generator 232, where based on the response received from the lead, the lead may be classified and officially assigned to an inside sales professional ending subsequent automated follow-up. More specifically, the response provided by the lead may be evaluated to determine if the lead should be qualified as a “Hot” lead or a “Warm” lead. Based on the qualification, the response generator 232 may assign the lead to a specified inside sales professional and/or inside sales group. Thus, additional information, such as the lead classification (e.g., “Hot” or “Warm”) and the additional information included in the lead's response may be associated with the lead information a CRM system and/or otherwise stored in a storage 260. Since the lead has been assigned to an inside sales professional or group, subsequent automated responses are prevented from occurring.

In instances where a response from a lead is not received, the response follow-up module 226 may be tasked with providing a follow-up message to the lead. For example, the response follow-up module 226 may retrieve status information for each lead in which an initial message has been sent. The response follow-up module 226 may add an indication to a CRM record for the lead and/or otherwise associate an indication to the lead indicating that a response has not been received and a subsequent follow-up message will be sent. Accordingly, the response follow-up module 226 may determine an optical schedule to send a second and/or third follow-up message. The second and/or third follow-up message may utilize a different template for example and may reference the sending of the first initial message. Thus, the second and/or third responses will include the same document response identifier and/or a document response identifier associated with the previous messages. The response follow-up module 226 may limit the number of follow-up response messages (for example two), and/or may determine an optimal date and/or time to send the follow-up messages. Since the purpose of the lead nurturing system 208 is to be as humanlike as can be, the subsequent follow-up communications may be sent during normal working hours (e.g., Monday to Friday between the hours of 10 AM and 3 PM), although other schedules are contemplated herein.

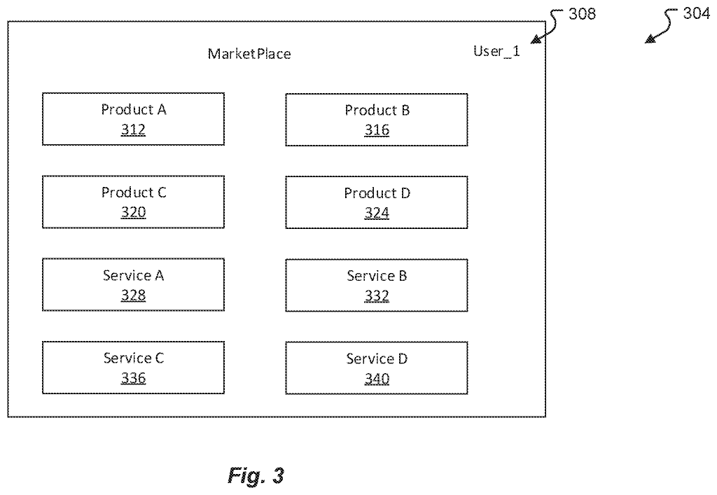

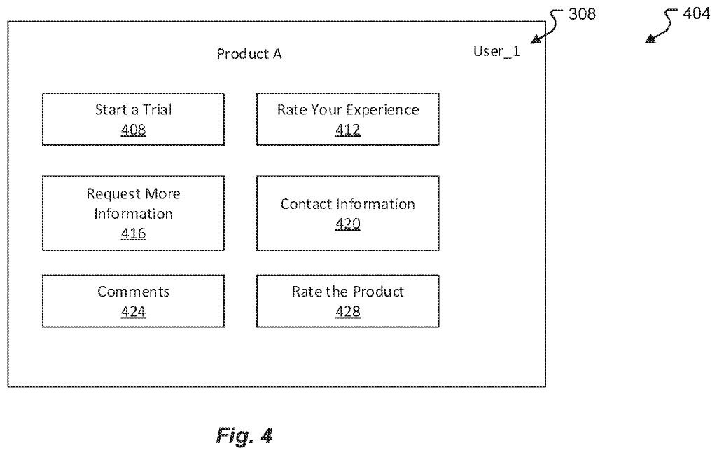

FIG. 3 depicts details of a marketplace 304 in accordance with examples of the present disclosure. More specifically, the marketplace 304 may include one or more products, such as products 312, 316, 320, and/or 324 which may be selectable by a user. The marketplace 304 may also include one or more services, such as services 328, 332, 336, and 340 selectable by a user. Moreover, a user may be signed into or otherwise associated with a marketplace 304. For example, the user may be signed in with a user name 308. Thus, the username uniquely identifies or otherwise is uniquely associated with an identifier that may be sent as part of the lead information 212. As depicted in FIG. 4, should a user click on product A, additional options may be available. For example, details 404 of product A may be presented. The details 404 represents a simplistic view of a request for additional information display which may be utilized by the lead interaction generator 108 to acquire and second lead information 212. For example, a user may start a trial by selecting start a trial 408. The user information 308 may be associated with lead identification information and send in the lead information 212. The user may have an option to rate an experience utilizing the rate experience option 412. Again, the user name 308 may be uniquely associated with an identifier that may be included in the lead information 212. Similarly, a selection of request more information 416, contact information 420, and/or comments 424, may present the user with an option to provide information directly to the lead interaction generator 108. By rating a product at 428, the lead nurturing system 208 may receive an initial indication of how happy, or unhappy, a user might be with an existing product and/or service.

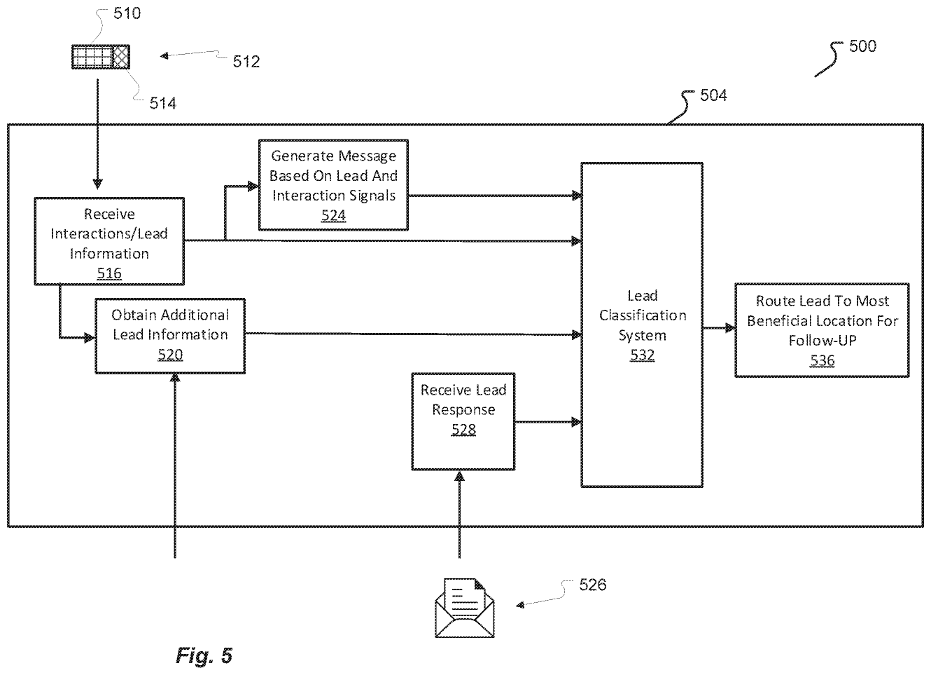

FIG. 5 depicts additional details of a lead nurturing system 504 in accordance with examples of the present disclosure. More specifically, lead information 512 may be received by the lead nurturing system 504 at 516. The lead information 512 may include a lead identifier 514 and interaction information 510. The lead information 512 may be the same as or similar to the lead information 212 as previously described. Additional information about the lead may be received at 520, where such information may be based on the lead identifier 514 and/or other lead identifying information. At 524, an initial message may be sent to the lead at 524 as previously discussed. For example, an email template may be selected based on the lead information 512 and/or an inside sales representative to which the lead may have been assigned. In instances where the lead provides a response 526 for example, the response may be received at 528 such that the response is provided to a lead classification system 532. The lead classification system 532 may make a determination as to whether the lead should be classified as a “Hot” lead and/or as a “Warm” lead based on the response received at 528, the lead information obtained at 520, the initial communication sent to the lead at 524, and the interactions and/or the lead information received at 516. That is, a neural network, and/or other machine learning algorithm may receive each of the previously mentioned inputs and make a determination as to how the lead should be classified. In addition, the lead classification system 532 may determine where to route a particular lead, ie., which inside sales professional and/or inside sales group to route the lead to. Accordingly, at 536 the lead may be routed to a specific individual and/or group based on the lead classification.

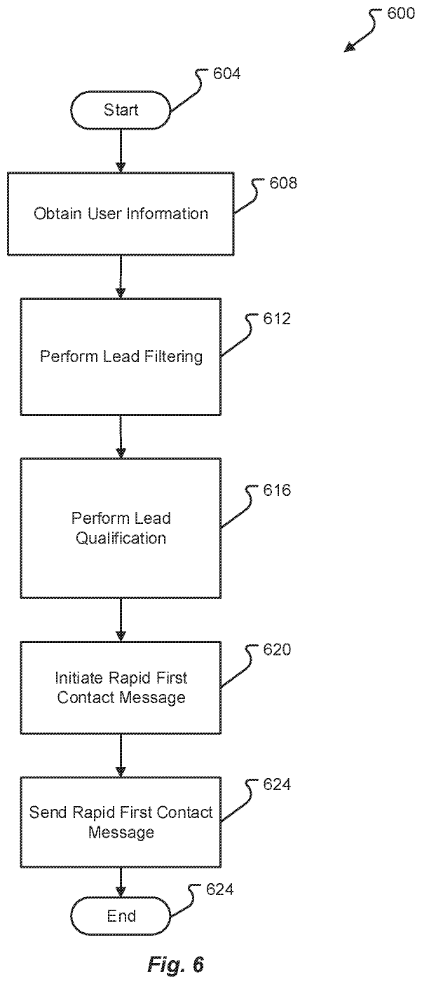

FIG. 6 depict details of a method 600 for sending a rapid first contact message based on lead and/or marketplace interaction information. A general order for the steps of the method 600 is shown in FIG. 6. Generally, the method 600 starts with a start operation 604 and ends with the end operation 624. The method 600 may include more or fewer steps or may arrange the order of the steps differently than those shown in FIG. 6. The method 600 can be executed as a set of computer-executable instructions executed by a computer system and encoded or stored on a computer readable medium. Further, the method 600 can be performed by gates or circuits associated with a processor, Application Specific Integrated Circuit (ASIC), a field programmable gate array (FPGA), a system on chip (SOC), or other hardware device. Hereinafter, the method 600 shall be explained with reference to the systems, components, modules, software, data structures, user interfaces, etc. described in conjunction with FIGS. 1-5.

The method 600 starts at 604 and proceeds to 608 where lead information is obtained. As previously discussed, the lead information may correspond to lead identification information and/or lead interaction information, where the lead interaction information occurs at a marketplace and/or an ecommerce site. The lead information may then be enriched and filtered at 612. For example, known leads indefinable by their contact information and/or context relevant to their contact information (such as an .edu domain) may be excluded from the rapid first contact message generation process. Moreover, the leads may be qualified at step 616 such that only those leads representing new opportunities may have a first contact message sent to them as previously discussed. At step 620, a rapid first contact message may be initiated. The message may be based on a template, the template being based on at last one of the interaction information of the lead, and/or an inside sales representative that may be initially or otherwise assigned to the lead. Moreover, the rapid first contact message may include an email sent to the user, a chat message sent to the user, a phone message sent to the user, a text message sent to the user, and/or any other message sent to the user. The method 600 may end at 624, after having sent the message to the user.

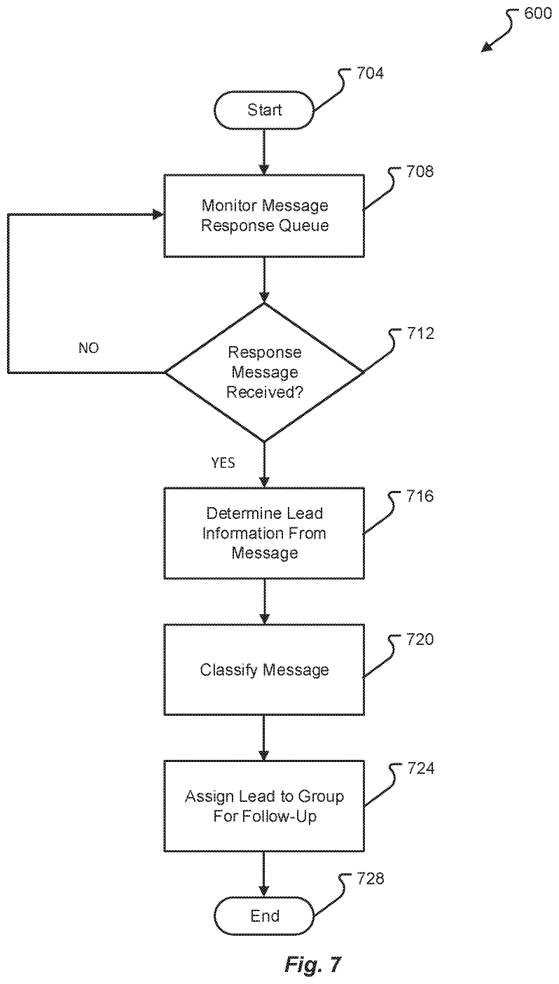

FIG. 7 depict details of a method 700 for monitoring a receipt of a message from a recipient and subsequently assigning the recipient to an inside sales professional when the recipient is a lead. A general order for the steps of the method 700 is shown in FIG. 7. Generally, the method 700 starts with a start operation 704 and ends with the end operation 728. The method 700 may include more or fewer steps or may arrange the order of the steps differently than those shown in FIG. 7. The method 700 can be executed as a set of computer-executable instructions executed by a computer system and encoded or stored on a computer readable medium. Further, the method 700 can be performed by gates or circuits associated with a processor, Application Specific Integrated Circuit (ASIC), a field programmable gate array (FPGA), a system on chip (SOC), or other hardware device. Hereinafter, the method 700 shall be explained with reference to the systems, components, modules, software, data structures, user interfaces, etc. described in conjunction with FIGS. 1-6.

The method 700 starts at 704 and proceeds to 708 where a message queue may be monitored. More specifically, a message queue, such as a mailbox, may be monitored to determine if a message from a lead is obtained. At step 712, if a reply message is not received, that is, the mailbox is empty, the method 700 may flow back to step 708. If a response, also referred to as a reply message, is received at step 712, lead information may be determined from the message at 716. For example, a document response identifier may be included in the response message. The document response identifier may be associated with lead information stored in a database or other storage area. Accordingly, based on the document response identifier, lead information, such as a lead identification and/or product information may be obtained from the database. At step 720, the response message may be classified to determine whether the response was indicative of a response generally associated with strong-negative sentiment or strong-positive sentiment. In cases where the potential lead responds with a “strong-negative” sentiment, the potential lead may be identified as a “Hot” lead and assigned to a group or specific inside sales professionals. That is, a “Hot” lead may be one which typically indicates a highest dis-satisfaction with a current product or service and may represent a large opportunity. Leads classified with a “strong-positive” sentiment tend to indicate a higher satisfaction and hence little opportunity, to turn the potential lead into an end customer. Such leads having a higher satisfaction may be classified as a “Warm” lead and may be provided to the inside sales professional with the “Warm” lead designation at 724. The method 700 may end at 728.

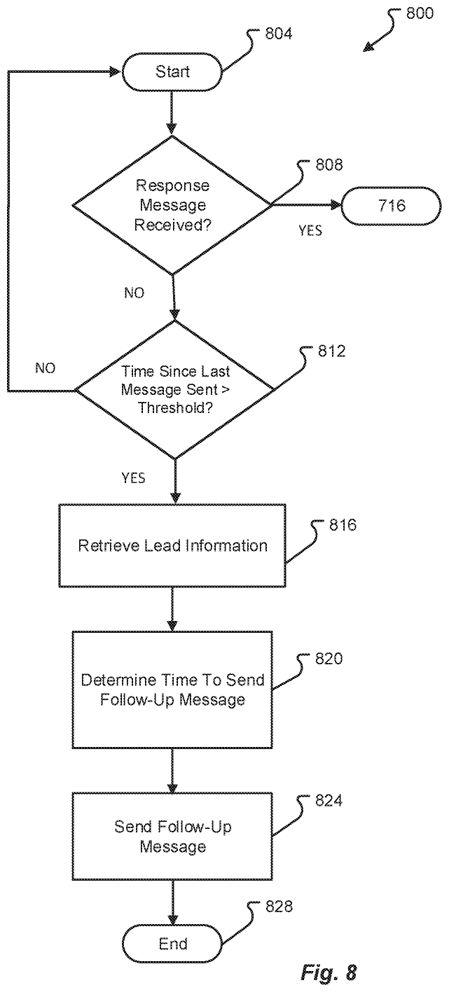

FIG. 8 depict details of a method 800 for monitoring a receipt of a message from a recipient and subsequently sending a follow-up message. A general order for the steps of the method 800 is shown in FIG. 8. Generally, the method 800 starts with a start operation 804 and ends with the end operation 828. The method 800 may include more or fewer steps or may arrange the order of the steps differently than those shown in FIG. 8. The method 800 can be executed as a set of computer-executable instructions executed by a computer system and encoded or stored on a computer readable medium. Further, the method 800 can be performed by gates or circuits associated with a processor, Application Specific Integrated Circuit (ASIC), a field programmable gate array (FPGA), a system on chip (SOC), or other hardware device. Hereinafter, the method 800 shall be explained with reference to the systems, components, modules, software, data structures, user interfaces, etc. described in conjunction with FIGS. 1-7.

The method 800 starts at 804 and proceeds to 808 where a message queue may be monitored. More specifically, a message queue, such as a mailbox, may be monitored to determine if a message from a lead is obtained. At step 808, if a reply message is received, the method 800 may flow to step 716 of method 700. At step 808, if a replay message is not received, the method 800 may flow to step 812 where a determination is made as to whether a an amount of time since the last message was sent is greater than a threshold. If a sufficient amount of time has not passed, that is if an amount of time since the last message was sent is not greater than a threshold, the method 800 may proceed back to 804. Alternatively, if a sufficient amount of time has passed since the last message was sent to the recipient (that is, the amount of time since the last message was sent is greater than a threshold), the method 800 proceeds to step 816 to retrieve additional lead information. More specifically, the message bus may provide a document response identifier which may be utilized to retrieve lead information at step 816. Based on the lead information, date and time, a follow-up message may be scheduled at step 820. For example, the response follow-up module 226 may determine an optical schedule to send a second and/or third follow-up message. The second and/or third follow-up message may utilize a different template for example and may reference the sending of the first initial message. Thus, the second and/or third message follow-ups will include the same document response identifier and/or a document response identifier associated with the previous messages. A number of follow-up response messages (for example two) may be limited, moreover an optimal date and/or time to send the follow-up messages may be determined. Since the purpose of the lead nurturing system 208 is to be as humanlike as can be, the subsequent follow-up communications may be sent during normal working hours (e.g., Monday to Friday between the hours of 10 AM and 3 PM), although other schedules are contemplated herein. Method 800 may proceed to step 824 where the follow-up message may be sent once the scheduled data and time is reached. The method 800 may then end at 828.

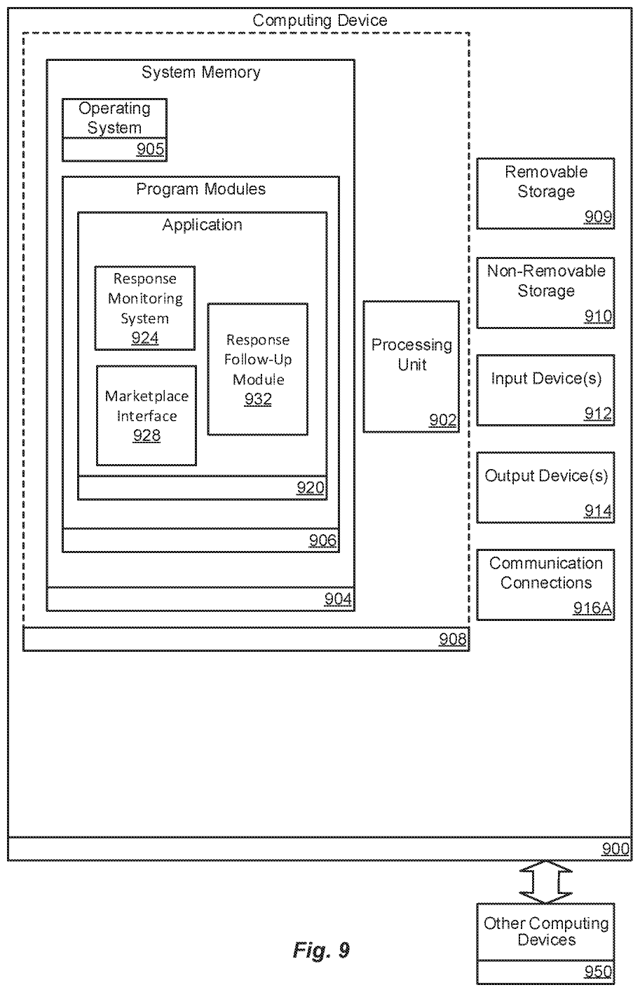

FIG. 9 is a block diagram illustrating physical components (e.g., hardware) of a computing device 900 with which aspects of the disclosure may be practiced. The computing device components described below may be suitable for the computing devices, such as the client device 116, and/or the lead nurturing component 120, as described above. In a basic configuration, the computing device 900 may include at least one processing unit 902 and a system memory 904. Depending on the configuration and type of computing device, the system memory 904 may comprise, but is not limited to, volatile storage (e.g., random access memory), non-volatile storage (e.g., read-only memory), flash memory, or any combination of such memories. The system memory 904 may include an operating system 905 and one or more program modules 906 suitable for performing the various aspects disclosed herein such as the response monitoring system 924, the marketplace interface 932, and/or the response follow-up module 932. The operating system 905, for example, may be suitable for controlling the operation of the computing device 900. Furthermore, aspects of the disclosure may be practiced in conjunction with a graphics library, other operating systems, or any other application program and is not limited to any particular application or system. This basic configuration is illustrated in FIG. 9 by those components within a dashed line 908. The computing device 900 may have additional features or functionality. For example, the computing device 900 may also include additional data storage devices (removable and/or non-removable) such as, for example, magnetic disks, optical disks, or tape. Such additional storage is illustrated in FIG. 9 by a removable storage device 909 and a non-removable storage device 910.

As stated above, a number of program modules and data files may be stored in the system memory 904. While executing on the processing unit 902, the program modules 906 (e.g., one or more applications 920) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 900 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 900 may also have one or more input device(s) 912 such as a keyboard, a mouse, a pen, a sound or voice input device, a touch or swipe input device, etc. The output device(s) 914 such as a display, speakers, a printer, etc. may also be included. The aforementioned devices are examples and others may be used. The computing device 900 may include one or more communication connections 916A allowing communications with other computing devices 950. Examples of suitable communication connections 916A include, but are not limited to, radio frequency (RF) transmitter, receiver, and/or transceiver circuitry, universal serial bus (USB), parallel, network interface card, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 904, the removable storage device 909, and the non-removable storage device 910 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 900. Any such computer storage media may be part of the computing device 900. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

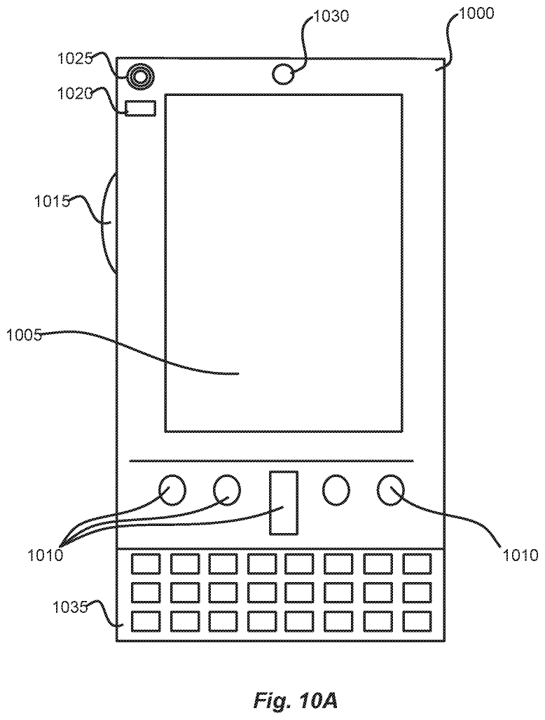

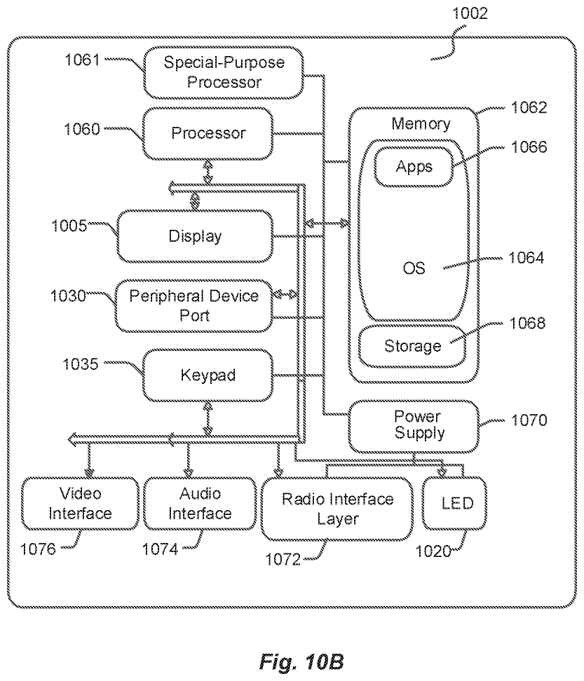

FIGS. 10A and 10B illustrate a computing device, client device, or mobile computing device 1000, for example, a mobile telephone, a smart phone, wearable computer (such as a smart watch), a tablet computer, a laptop computer, and the like, with which aspects of the disclosure may be practiced. In some aspects, the client device (e.g., 116A-116E) may be a mobile computing device. With reference to FIG. 10A, one aspect of a mobile computing device 1000 for implementing the aspects is illustrated. In a basic configuration, the mobile computing device 1000 is a handheld computer having both input elements and output elements. The mobile computing device 1000 typically includes a display 1005 and one or more input buttons 1010 that allow the user to enter information into the mobile computing device 1000. The display 1005 of the mobile computing device 1000 may also function as an input device (e.g., a touch screen display). If included, an optional side input element 1015 allows further user input. The side input element 1015 may be a rotary switch, a button, or any other type of manual input element. In alternative aspects, mobile computing device 1000 may incorporate more or less input elements. For example, the display 1005 may not be a touch screen in some aspects. In yet another alternative aspect, the mobile computing device 1000 is a portable phone system, such as a cellular phone. The mobile computing device 1000 may also include an optional keypad 1035. Optional keypad 1035 may be a physical keypad or a “soft” keypad generated on the touch screen display. In various aspects, the output elements include the display 1005 for showing a graphical user interface (GUI), a visual indicator 1020 (e.g., a light emitting diode), and/or an audio transducer 1025 (e.g., a speaker). In some aspects, the mobile computing device 1000 incorporates a vibration transducer for providing the user with tactile feedback. In yet another aspect, the mobile computing device 1000 incorporates input and/or output ports, such as an audio input (e.g., a microphone jack), an audio output (e.g., a headphone jack), and a video output (e.g., a HDMI port) for sending signals to or receiving signals from an external source.

FIG. 10B is a block diagram illustrating the architecture of one aspect of computing device, a server, or a mobile computing device. That is, the computing device 1000 can incorporate a system (e.g., an architecture) 1002 to implement some aspects. The system 1002 can implemented as a “smart phone” capable of running one or more applications (e.g., browser, e-mail, calendaring, contact managers, messaging clients, games, and media clients/players). In some aspects, the system 1002 is integrated as a computing device, such as an integrated personal digital assistant (PDA) and wireless phone.

One or more application programs 1066 may be loaded into the memory 1062 and run on or in association with the operating system 1064. Examples of the application programs include phone dialer programs, lead nurturing programs, e-mail programs, personal information management (PIM) programs, word processing programs, spreadsheet programs, Internet browser programs, messaging programs, and so forth. The system 1002 also includes a non-volatile storage area 1068 within the memory 1062. The non-volatile storage area 1068 may be used to store persistent information that should not be lost if the system 1002 is powered down. The application programs 1066 may use and store information in the non-volatile storage area 1068, such as e-mail or other messages used by an e-mail application, title content, and the like. A synchronization application (not shown) also resides on the system 1002 and is programmed to interact with a corresponding synchronization application resident on a host computer to keep the information stored in the non-volatile storage area 1068 synchronized with corresponding information stored at the host computer. As should be appreciated, other applications may be loaded into the memory 1062 and run on the mobile computing device 1000 described herein (e.g., search engine, extractor module, relevancy ranking module, answer scoring module, etc.).

The system 1002 has a power supply 1070, which may be implemented as one or more batteries. The power supply 1070 might further include an external power source, such as an AC adapter or a powered docking cradle that supplements or recharges the batteries.

The system 1002 may also include a radio interface layer 1072 that performs the function of transmitting and receiving radio frequency communications. The radio interface layer 1072 facilitates wireless connectivity between the system 1002 and the “outside world,” via a communications carrier or service provider. Transmissions to and from the radio interface layer 1072 are conducted under control of the operating system 1064. In other words, communications received by the radio interface layer 1072 may be disseminated to the application programs 1066 via the operating system 1064, and vice versa.

The visual indicator 1020 may be used to provide visual notifications, and/or an audio interface 1074 may be used for producing audible notifications via the audio transducer 1025. In the illustrated configuration, the visual indicator 1020 is a light emitting diode (LED) and the audio transducer 1025 is a speaker. These devices may be directly coupled to the power supply 1070 so that when activated, they remain on for a duration dictated by the notification mechanism even though the processor 1060 and other components might shut down for conserving battery power. The LED may be programmed to remain on indefinitely until the user takes action to indicate the powered-on status of the device. The audio interface 1074 is used to provide audible signals to and receive audible signals from the user. For example, in addition to being coupled to the audio transducer 1025, the audio interface 1074 may also be coupled to a microphone to receive audible input, such as to facilitate a telephone conversation. In accordance with aspects of the present disclosure, the microphone may also serve as an audio sensor to facilitate control of notifications, as will be described below. The system 1002 may further include a video interface 1076 that enables an operation of an on-board camera 1030 to record still images, video stream, and the like.

A mobile computing device 1000 implementing the system 1002 may have additional features or functionality. For example, the mobile computing device 1000 may also include additional data storage devices (removable and/or non-removable) such as, magnetic disks, optical disks, or tape. Such additional storage is illustrated in FIG. 10B by the non-volatile storage area 1068.

Data/information generated or captured by the mobile computing device 1000 and stored via the system 1002 may be stored locally on the mobile computing device 1000, as described above, or the data may be stored on any number of storage media that may be accessed by the device via the radio interface layer 1072 or via a wired connection between the mobile computing device 1000 and a separate computing device associated with the mobile computing device 1000, for example, a server computer in a distributed computing network, such as the Internet. As should be appreciated such data/information may be accessed via the mobile computing device 1000 via the radio interface layer 1072 or via a distributed computing network. Similarly, such data/information may be readily transferred between computing devices for storage and use according to well-known data/information transfer and storage means, including electronic mail and collaborative data/information sharing systems.

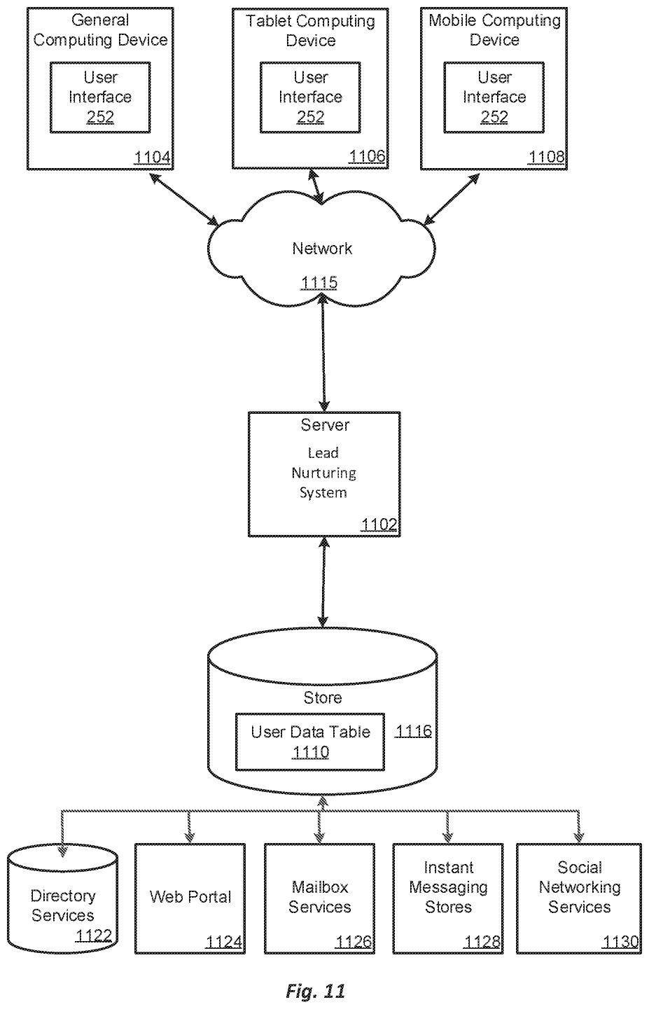

FIG. 11 illustrates one aspect of the architecture of a system for processing data received at a computing system 1102 (e.g., content provider 108) from a remote source, as described above. Content at a server device 1102 may be stored in different communication channels or other storage types. For example, various images, or files may be stored using a directory service 1122, a web portal 1124, a mailbox service 1126, an instant messaging store 1128, or a social networking site 1130. A unified profile API based on the user data table 1110 may be employed by a client that communicates with server device 1102. The server device 1102 may provide data to and from a client computing device such as the client devices 116A-116C through a network 1115. By way of example, the client device 116 described above may be embodied in a personal computer 1104, a tablet computing device 1106, and/or a mobile computing device 1108 (e.g., a smart phone).

The above specification, examples and data provide a complete description of the manufacture and use of the composition of the invention. Since many aspects of the invention can be made without departing from the spirit and scope of the invention, the invention resides in the claims hereinafter appended.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The exemplary systems and methods of this disclosure have been described in relation to computing devices. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infrared data communications.

Any of the steps, functions, and operations discussed herein can be performed continuously and automatically.

While the flowcharts have been discussed and illustrated in relation to a particular sequence of events, it should be appreciated that changes, additions, and omissions to this sequence can occur without materially affecting the operation of the disclosed configurations and aspects.

A number of variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions that may be implemented with particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, sub combinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an configuration with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

In accordance with examples of the present disclosure, a system for nurturing one or more leads is provided. The system may include at least one processor and at least one memory including instructions which when executed by the at least one processor, causes the at least one processor to receive an indication that a user has interacted with an ecommerce site, receive information uniquely identifying the user that interacted with the ecommerce site, obtain contact information for the user based on the information uniquely identifying the user, and send a communication message to the user, the communication message including a document response identifier associated with the information uniquely identifying the user, receive a reply communication message from the user, the reply communication message including the document response identifier, and associate the user with at least one of a group and/or an inside sales professional.

In accordance with at least one aspect of the present disclosure, the one or more instructions, which when executed by the at least one processor, may cause the at least one processor to classify the user as an important lead based on the reply communication message. Further still, the one or more instructions, which when executed by the at least one processor, may cause the at least one processor to determine that a response from the user has not been received, and automatically send a follow-up message to the user after a predetermined period of time. In some aspects, the communication message sent to the user may be sent within a predetermined period of time. Further, in some aspects, the predetermined period of time may be forty-five minutes. In accordance with at least one aspect of the present disclosure, the one or more instructions, which when executed by the at least one processor, may cause the at least one processor to obtain a messaging template based on information received in the indication that the user has interacted with the ecommerce site, and send the communication message to the user utilizing the messaging template. Further still, the one or more instructions, which when executed by the at least one processor, may cause the at least one processor to determine that a response from the user has not been received, and automatically send a follow-up message to the user after a predetermined period of time, the follow-up message being based on an messaging template that is different from the messaging template used to send a previous communication message to the user. In at least one aspect, the communication message is an email.

In accordance with examples of the present disclosure, a method of nurturing one or more leads is provided. The method may include receiving an indication that a user has interacted with an ecommerce site, the indication including information uniquely identifying the user and one or more interactions with the ecommerce site, retrieving contact information for the user based on the information uniquely identifying the user, sending a communication message to the user utilizing the contact information, the communication message including a document response identifier associated with the information uniquely identifying the user, receiving a reply communication message from the user, the reply communication message including the document response identifier, and associating the user with at least one of a group and/or an inside sales professional.

In accordance with at least one aspect of the present disclosure, the communication message sent to the user is a first email and the reply communication from the user is a second email. In some aspects, the method may include classifying the user as an important lead based on the reply communication message. Further, additional aspects may include selecting a template for the communication message based on the one or more interactions with the ecommerce site. In some aspects, the method may include determining that a response from the user has not been received within a period of time, and automatically scheduling a follow-up message to be sent to the user after the predetermined period of time, the follow-up message based on an messaging template that is different from the messaging template used to send a previous communication message to the user. Further yet, some aspects may include rescheduling the follow-up message to the user if the follow-up message was scheduled to be sent on a weekend.

In accordance with examples of the present disclosure, a method of nurturing one or more leads is provided. The method may include receiving an indication that a lead has interacted with an ecommerce site, the indication including information uniquely identifying the lead and one or more interactions with the ecommerce site, retrieving contact information for the lead based on the information uniquely identifying the lead, qualifying the lead based on the information identifying one or more interactions with the ecommerce site, associating the lead with at least one of a sales professional or sales group, selecting a template based on the at least one of the sales professional or sales group, and sending a communication message to the lead utilizing the contact information and the selected template, wherein the communication message includes sender information associated with at least one of the sales professional or sales group.

In accordance with at least one aspect of the present disclosure, the method may include receiving a reply communication message from the lead, the reply communication message including a document response identifier that was included in the communication message sent to the lead. In some aspects, the communication message sent to the lead is a first email and the reply communication from the lead is a second email. Further still, in accordance with some aspects, the method may include classifying the lead as an important lead based on the reply communication message. In some aspects, the method may include selecting a template for the communication message based on the one or more interactions with the ecommerce site. Further still, in some aspects, the method may include determining that a response communication from the lead has not been received within a period of time, and automatically scheduling a follow-up message to be sent to the lead after the predetermined period of time, the follow-up message based on an messaging template that is different from the template used to send a previous communication message to the user.

What is claimed is:

1. A system for nurturing one or more leads, the system comprising:
at least one processor; and
at least one memory including instructions which when executed by the at least one processor, causes the at least one processor to:
receive an indication that a user has interacted with an ecommerce site;
receive information uniquely identifying the user that interacted with the ecommerce site;
obtain contact information for the user based on the information uniquely identifying the user;
send a communication message to the user, the communication message including a document response identifier associated with the information uniquely identifying the user;
receive a reply communication message from the user, the reply communication message including the document response identifier; and
associate the user with at least one of a group and/or an inside sales professional.

2. The system of claim 1, further comprising one or more instructions, which when executed by the at least one processor, causes the at least one processor to:
classify the user as an important lead based on the reply communication message.

3. The system of claim 1, further comprising one or more instructions, which when executed by the at least one processor, causes the at least one processor to:
determine that a response from the user has not been received; and
automatically send a follow-up message to the user after a predetermined period of time.

4. The system of claim 1, wherein the communication message sent to the user is sent within a predetermined period of time.

5. The system of claim 4, wherein the predetermined period of time is forty-five minutes.

6. The system of claim 1, further comprising one or more instructions, which when executed by the at least one processor, causes the at least one processor to:
obtain a messaging template based on information received in the indication that the user has interacted with the ecommerce site; and
send the communication message to the user utilizing the messaging template.

7. The system of claim 6, further comprising one or more instructions, which when executed by the at least one processor, causes the at least one processor to:
determine that a response from the user has not been received; and
automatically send a follow-up message to the user after a predetermined period of time, the follow-up message being based on an messaging template that is different from the messaging template used to send a previous communication message to the user.

8. The system of claim 1, wherein the communication message is an email.

9. A method of nurturing one or more leads comprising:
receiving an indication that a user has interacted with an ecommerce site, the indication including information uniquely identifying the user and one or more interactions with the ecommerce site;
retrieving contact information for the user based on the information uniquely identifying the user;
sending a communication message to the user utilizing the contact information, the communication message including a document response identifier associated with the information uniquely identifying the user;
receiving a reply communication message from the user, the reply communication message including the document response identifier; and
associating the user with at least one of a group and/or an inside sales professional.

10. The method of claim 9, wherein the communication message sent to the user is a first email and the reply communication from the user is a second email.

11. The method of claim 9, further comprising:
classifying the user as an important lead based on the reply communication message.

12. The method of claim 9, further comprising:
selecting a template for the communication message based on the one or more interactions with the ecommerce site.

13. The method of claim 9, further comprising:
determining that a response from the user has not been received within a period of time; and
automatically scheduling a follow-up message to be sent to the user after the predetermined period of time, the follow-up message based on an messaging template that is different from the messaging template used to send a previous communication message to the user.

14. The method of claim 13, rescheduling the follow-up message to the user if the follow-up message was scheduled to be sent on a weekend.

15. A method of nurturing one or more leads comprising:
receiving an indication that a lead has interacted with an ecommerce site, the indication including information uniquely identifying the lead and one or more interactions with the ecommerce site;
retrieving contact information for the lead based on the information uniquely identifying the lead;
qualifying the lead based on the information identifying one or more interactions with the ecommerce site;
associating the lead with at least one of a sales professional or sales group;
selecting a template based on the at least one of the sales professional or sales group; and
sending a communication message to the lead utilizing the contact information and the selected template, wherein the communication message includes sender information associated with at least one of the sales professional or sales group.

16. The method of claim 15, further comprising:
receiving a reply communication message from the lead, the reply communication message including a document response identifier that was included in the communication message sent to the lead.

17. The method of claim 15, wherein the communication message sent to the lead is a first email and the reply communication from the lead is a second email.

18. The method of claim 15, further comprising:
classifying the lead as an important lead based on the reply communication message.

19. The method of claim 15, further comprising:
selecting a template for the communication message based on the one or more interactions with the ecommerce site.

20. The method of claim 19, further comprising:
determining that a response communication from the lead has not been received within a period of time; and
automatically scheduling a follow-up message to be sent to the lead after the predetermined period of time, the follow-up message based on an messaging template that is different from the template used to send a previous communication message to the user.
